(19) United States
(12) Patent Application Publication
(10) Pub. No.: US 2015/0287131 A1
(43) Pub. Date: Oct. 8, 2015

(54) AUCTION METHOD AND SYSTEM FOR ALLOCATION OF MOBILE CLOUD RESOURCES

(71) Applicant: Tsinghua University, Beijing (CN)

(72) Inventors: KE XU, Beijing (CN); XUELIN SHI, Beijing (CN); YUCHAO ZHANG, Beijing (CN); YONG WANG, Beijing (CN)

(21) Appl. No.: 14/636,873

(22) Filed: Mar. 3, 2015

(30) Foreign Application Priority Data
Mar. 6, 2014 (CN) 201410081070.4

(51) Int. Cl. G06Q 30/08

(52) U.S. Cl. CPC G06Q 30/08

(57) ABSTRACT

A method and a system for an online electronic auction are provided. The method includes following steps. A first bid price is obtained from a client. A second bid price is obtained from a cloud service provider. The client and the cloud service provider that win the auction and a transaction price thereof are obtained according to the first bid price and the second bid price, and identification information of the client and the cloud service provider that win the auction is matched with each other such that the client and the cloud service provider can complete an online payment according to the matched identification information.

### CROSS REFERENCE TO RELATED APPLICATION

This application claims priority to and benefits of Chinese Patent Application No. 201410081070.4, filed with State Intellectual Property Office on Mar. 6, 2014, the entire content of which is incorporated herein by reference.

### FIELD

Embodiments of the present disclosure generally relate to a resource allocation technology of a mobile cloud resource, and more particularly, to an auction method for an allocation of a mobile cloud resource and an auction system for an allocation of a mobile cloud resource.

### BACKGROUND

With the development of the wireless access network such as WiFi and 3G, the smart phone and the mobile terminal have been used widely, and more and more users depend on the mobile computing. However, the mobile computing itself has following defects: limitation of computing and memory property of the mobile terminal, low network bandwidth of the wireless access network and poor quality of the wireless access network in certain conditions, and difficulty in operating for the moving user, which reduce the user's experience enormously. The mobile cloud computing, as a combination of the cloud computing and the wireless network, provides the mobile user with a computing and memory service, which is seamless and has a more powerful function. The mobile terminal can visit the external cloud resource to satisfy the requirement of some larger computing and memories. Therefore, the mobile cloud computing has been an important branch of the cloud computing.

With the popularity of the mobile cloud computing and the increase of the mobile terminal users, just like the Internet access service, the mobile cloud service will become a service market destined for customers. However, at the same time, higher requirements are proposed for the dynamic allocation, the market mechanism design and the pricing strategy of the mobile cloud resource.

Auction is an efficient market mechanism, and the cloud resource is suitable for merchandises traded in the form of auction due to its own characteristics. Currently, some simple auction models have been used in the conventional wired cloud computing market. However, due to the new characteristics of the mobile cloud computing, such as the limitation of performance of the mobile terminal, the limited bandwidth and high cost of the wireless network, these auction models are not suitable to be used in the mobile cloud market. In other words, there has not been an auction mechanism suitable for the mobile cloud resource allocation so far.

### SUMMARY

Embodiments of the present disclosure seek to solve at least one of the problems existing in the related art to at least some extent.

Accordingly, a first object of the present disclosure is to provide an auction method for an allocation of a mobile cloud resource, which allows a mobile user (i.e. a client) and a mobile cloud service provider (i.e. a cloud service provider) to complete an online auction with each other, and uses a combinatorial auction that is convenient for a user to use, i.e., the user can bid for a group of merchandises, thus ensuring a great flexibility. In addition, the method also uses a double auction mechanism, which allows the mobile user and the cloud service provider to bid at a same time, thus improving a market efficiency of the auction.

In order to achieve above objects, embodiments of a first aspect of the present disclosure provide an auction method for an allocation of a mobile cloud resource, including: obtaining a first bid price from a client, wherein the first bid price is provided by the client about a quantity unit and a price of one or more merchandises to be wanted; obtaining a second bid price from a cloud service provider, wherein the second bid price is provided by the cloud service provider about a quantity unit and a price of one or more merchandises to be sold; obtaining the client and the cloud service provider that win the auction and a transaction price thereof according to the first bid price from the client and the second bid price from the cloud service provider; and matching identification information of the client and the cloud service provider that win the auction with each other such that the client and the cloud service provider can complete an online payment according to the matched identification information.

With the auction method for an allocation of a mobile cloud resource, in the auction, the client (i.e. the buyer) provides the first bid price about the quantity unit and the price of one or more merchandises to be wanted, and the could service provider (i.e. the seller) provides the second bid price about the quantity unit and the price of one or more merchandises to be sold; in the winner determination stage, the online auction platform obtains the client and the cloud service provider that win the auction and the transaction price thereof according to the first bid price and the second bid price; finally, the online platform matches identification information of the client and the cloud service provider that win the auction with each other, such that the corresponding client and the cloud service provider completes the online payment according to the matched identification information. Therefore, the client (i.e. the buyer) and the cloud service provider (i.e. seller) can provide a bid price at the same time, and also can bid for and sell a combination of merchandises respectively, which implements a reasonable allocation and a price fixing of the mobile cloud resource, and thus the method has great flexibility and high market efficiency.

In some embodiments, obtaining the client and the cloud service provider that win the auction and a transaction price thereof according to the first bid price from the client and the second bid price from the cloud service provider includes: establishing a winner determination model according to the first bid price and the second bid price in order to maximize an overall revenue of the client and the cloud service provider; and solving the winner determination model to obtain the client and the cloud service provider that win the auction and the transaction price thereof.

In some embodiments, the winner determination model is denoted as formula (1):

$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ \hat{{B}_{i} ( 1 )}} {x}_{i} = {\sum }_{j ∈ \hat{J} , r = {\hat{A}}_{j} ( 1 )} {y}_{j} \text{∀} r ∈ \hat{R} \\ {y}_{j} ∈ \{ 0 , 1 , … , {q}_{j} \} \text{∀} j ∈ \hat{J} \\ {x}_{i} ∈ \{ 0 , 1 \} \text{∀} i ∈ \hat{I} \qquad ( 1 )$$

where Î is a set of clients; Ĵ is a set of cloud service providers; xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; \hat{R} is a merchandise set; B_{î}(1) is a set of first bid price accepted by the i^{th} client; A_{ĵ}(1) is a set of second bid price accepted by the j^{th} cloud service provider.

In some embodiments, solving the winner determination model to obtain the client and the cloud service provider that win the auction and the transaction price thereof includes:

obtaining the utility function of the i^{th} client according to formula (2),

$${U}_{i} ( {S}_{i} ) = {v}_{i}^{S} - {\sum }_{r ∈ S} {P}_{i}^{r} \qquad ( 2 )$$

where S is a set of merchandises to be wanted, vᵢ^{S} is a total cost of merchandises in S in the first bid price of the i^{th} client,

$${\sum }_{r ∈ S} {P}_{i}^{r}$$

is an actual transaction price of merchandises in S;

obtaining the revenue function of the j^{th} cloud service provider according to formula (3),

Wⱼ(rⱼ)=Pⱼ^{r}−cⱼ^{r} (3)

where Pⱼ^{r} is an actual transaction price of the r^{th} merchandise of the j^{th} cloud service provider, cⱼ^{r} is a second bid price of the r^{th} merchandise of the j^{th} cloud service provider;

simplifying formula (1) into formula (4) according to formula (2) and formula (3):

$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 \text{∀} r ∈ \hat{R} \\ {y}_{j} ∈ \{ 0 , 1 , … , {q}_{j} \} \text{∀} j ∈ \hat{J} \\ {x}_{i} ∈ \{ 0 , 1 \} \text{∀} i ∈ \hat{I} \qquad ( 4 )$$

where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element aᵣⱼ in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0);

introducing a Lagrangian relaxation factor λ into formula (4) to obtain formula (5),

z_{LR}(λ)=max L(x,y;λ)

s.t. 0≦yⱼ≦qⱼ∀jεĴ

0≦xᵢ≦1∀iεÎ (5)

where

$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) ,$$

LD presents a dual problem of the winner determination problem IP;

obtaining the dual problem LD of the winner determination problem IP according to formula (6),

z_{LD}=min z_{LR}(λ)

s.t. λᵣ≧0∀rε\hat{R} (6)

solving the dual problem LD by a sub-gradient algorithm to obtain the client and the cloud service provider that win the auction and the transaction price thereof in a predetermined iteration scope, where a sub-gradient is denoted as formula (7),

g=∂L(x,y;λ)/∂λ (7)

wherein in each iteration, the Lagrangian relaxation factor λ is changed along a direction of the sub-gradient according to formula (8),

λ^{(k+1)}=λ^{(k)}+t^{(k)}g^{(k)} (8),

where t^{(k)} is an iterative step, g^{(k)} is a sub-gradient of each iteration.

In some embodiments, the first bid price is provided by the client through:

inputting (<S,v^{S}>) via a predetermined auction language to indicate that the client intents to purchase one unit of each kind of merchandises in a merchandise to be wanted set S with a total cost v^{S}, if the merchandises intended to be wanted are a group of merchandises with independent or complementary efficiencies and a required quantity of the each kind of merchandises is one unit;

inputting (<S,v^{S}>)^{≦n} via the predetermined auction language to indicate that the client intents to purchase one to n units of the each kind of merchandises in the set S respectively in which a total cost of one unit of the each kind of merchandises in the set S is v^{S}, if the merchandises intended to be wanted are the group of merchandises with independent or complementary efficiencies and the required quantity of the each kind of merchandises is at least one unit, wherein n is an integer larger than one;

inputting (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, if the merchandises intended to be wanted are a group of merchandises with substitutable efficiencies and a required quantity of the each kind of merchandises is one unit, wherein S₁∩S₂=Ø; and

inputting (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, if the merchandises intended to be wanted are the group of merchandises with substitutable efficiencies and the required quantity of the each kind of merchandises is at least one unit, wherein n is an integer larger than one.

In some embodiments, the method further includes: receiving an application for taking part in the auction from the client and the cloud service provider respectively; and taking an authentication and an examination to complete an online registration for the client and the cloud service provider respectively such that the client and the cloud service provider distribute auction information online.

In some embodiments, the method further includes: setting a price lower limit of the client in the auction, wherein the first bid price of each merchandise from the client is larger than the price lower limit, and the price lower limit of the client is adjustable according to a previous deal record.

In some embodiments, the method further includes: setting a price upper limit of the cloud service provider in the auction, wherein the second bid price of each merchandise from the cloud service provider is less than the price upper limit, and the price upper limit of the cloud service provider is adjustable according to the previous deal record.

Embodiments of a second aspect of the present disclosure provide an auction system for an allocation of a mobile cloud resource, including: a client configured to provide a first bid price about a quantity unit and a price of one or more merchandises to be wanted; a cloud service provider configured to provide a second bid price about a quantity unit and a price of one or more merchandises to be sold; and an online auction platform configured to obtain the client and the cloud service provider that win the auction and a transaction price thereof according to the first bid price from the client and the second bid price from the cloud service provider and to match identification information of the client and the cloud service provider that win the auction with each other such that the client and the cloud service provider can complete an online payment according to the matched identification information.

With the auction system for an allocation of a mobile cloud resource according to embodiments of the present disclosure, in the auction, the client (i.e. the buyer) provides the first bid price about the quantity unit and the price of one or more merchandises to be wanted, and the could service provider (i.e. the seller) provides the second bid price about the quantity unit and the price of one or more merchandises to be sold; in the winner determination stage, the online auction platform obtains the client and the cloud service provider that win the auction and the transaction price thereof according to the first bid price and the second bid price; finally, the online platform matches identification information of the client and the cloud service provider that win the auction with each other, such that the corresponding client and the cloud service provider completes the online payment according to the matched identification information. Therefore, the client (i.e. the buyer) and the cloud service provider (i.e. seller) can provide a bid price at the same time, and also can bid for and sell a combination of merchandises respectively, which implements a reasonable allocation and a price fixing of the mobile cloud resource, and thus the method has great flexibility and high market efficiency.

In some embodiments, the online auction platform is configured to: establish a winner determination model according to the first bid price and the second bid price in order to maximize an overall revenue of the client and the cloud service provider; and solve the winner determination model to obtain the client and the cloud service provider that win the auction and the transaction price thereof.

In some embodiments, the winner determination model is denoted as:

$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ \hat{{B}_{i} ( 1 )}} {x}_{i} = {\sum }_{j ∈ \hat{J} , r = {\hat{A}}_{j} ( 1 )} {y}_{j} \text{∀} r ∈ \hat{R} \\ {y}_{j} ∈ \{ 0 , 1 , … , {q}_{j} \} \text{∀} j ∈ \hat{J} \\ {x}_{i} ∈ \{ 0 , 1 \} \text{∀} i ∈ \hat{I} \qquad ( 1 )$$

where Î is a set of clients; Ĵ is a set of cloud service providers; xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; \hat{R} is a merchandise set; B_{î}(1) is a set of first bid price accepted by the i^{th} client; A_{ĵ}(1) is a set of second bid price accepted by the j^{th} cloud service provider.

In some embodiments, the online auction platform is further configured to:

obtain the utility function of the i^{th} client according to formula (2),

$${U}_{i} ( {S}_{i} ) = {v}_{i}^{S} - {\sum }_{r ∈ S} {P}_{i}^{r} \qquad ( 2 )$$

where S is a set of merchandises to be wanted, vᵢ^{S} is a total cost of merchandises in S in the first bid price of the i^{th} client,

$${\sum }_{r ∈ S} {P}_{i}^{r}$$

is an actual transaction price of merchandises in S;

obtain the revenue function of the j^{th} cloud service provider according to formula (3),

Wⱼ(rⱼ)=Pⱼ^{r}−cⱼ^{r} (3)

where Pⱼ^{r} is an actual transaction price of a r^{th} merchandise of the j^{th} cloud service provider, cⱼ^{r} is a second bid price of the r^{th} merchandise of the j^{th} cloud service provider;

simplify formula (1) into formula (4) according to formula (2) and formula (3):

$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 \text{∀} r ∈ \hat{R} \\ {y}_{j} ∈ \{ 0 , 1 , … {q}_{j} \} \text{∀} j ∈ \hat{J} \\ {x}_{i} ∈ \{ 0 , 1 \} \text{∀} i ∈ \hat{I} \qquad ( 4 )$$

where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element aᵣⱼ in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0);

introduce a Lagrangian relaxation factor λ into formula (4) to obtain formula (5),

z_{LR}(λ)=max L(x,y;λ)

s.t. 0≦yⱼ≦qⱼ∀jεĴ

0≦xᵢ≦1∀iεÎ (5)

where

$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) ,$$

LD presents a dual problem of the winner determination problem IP;

obtain the dual problem LD of the winner determination problem IP according to formula (6),

z_{LD}=min z_{LR}(λ)

s.t. λᵣ≧0∀rε\hat{R} (6)

solve the dual problem LD by a sub-gradient algorithm to obtain the client and the cloud service provider that win the auction and the transaction price thereof in a predetermined iteration scope, where a sub-gradient is denoted as formula (7),

g=∂L(x,y;λ)/∂λ (7)

wherein in each iteration, the Lagrangian relaxation factor λ is changed along a direction of the sub-gradient according to formula (8),

λ^{(k+1)}=λ^{(k)}+t^{(k)}g^{(k)} (8),

where t^{(k)} is an iterative step, g^{(k)} is a sub-gradient of each iteration.

In some embodiments, the client is configured to:

input (<S,v^{S}>) via a predetermined auction language to indicate that the client intents to purchase one unit of each kind of merchandises in a merchandise to be wanted set S with a total cost v^{S}, if the merchandises intended to be wanted are a group of merchandises with independent or complementary efficiencies and a required quantity of the each kind of merchandises is one unit;

input (<S,v^{S}>)^{≦n} via the predetermined auction language to indicate that the client intents to purchase one to n units of the each kind of merchandises in the set S respectively in which a total cost of one unit of the each kind of merchandises in the set S is v^{S}, if the merchandises intended to be wanted are the group of merchandises with independent or complementary efficiencies and the required quantity of the each kind of merchandises is at least one unit, wherein n is an integer larger than one;

input (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, if the merchandises intended to be wanted are a group of merchandises with substitutable efficiencies and a required quantity of the each kind of merchandises is one unit, wherein S₁∩S₂=Ø; and input (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, if the merchandises intended to be wanted are the group of merchandises with substitutable efficiencies and the required quantity of the each kind of merchandises is at least one unit, wherein n is an integer larger than one.

In some embodiments, the online auction platform is configured to: receive an application for taking part in the auction from the client and the cloud service provider respectively; and take an authentication and an examination to complete an online registration for the client and the cloud service provider respectively such that the client and the cloud service provider distribute auction information online.

In some embodiments, the online auction platform is further configured to set a price lower limit of the client in the auction, wherein the first bid price of each merchandise from the client is larger than the price lower limit, and the price lower limit of the client is adjustable according to a previous deal record.

In some embodiments, the online auction platform is further configured to set a price upper limit of the cloud service provider in the auction, wherein the second bid price of each merchandise from the cloud service provider is less than the price upper limit, and the price upper limit of the cloud service provider is adjustable according to the previous deal record.

Embodiments of a third aspect of the present disclosure provide a non-transit computer-readable storage medium. The non-transit computer-readable storage medium includes a computer program for executing the auction method for an allocation of a mobile cloud resource according to the first aspect of the present disclosure when running on a computer.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of an auction method for an allocation of a mobile cloud resource according to an embodiment of the present disclosure;

FIG. 2 is a schematic diagram of an auction method for an allocation of a mobile cloud resource according to an embodiment of the present disclosure;

FIG. 3 is a schematic diagram of a scene in which a client uses a cloud service according to an embodiment of the present disclosure;

FIG. 4 is a flow chart of an auction method for an allocation of a mobile cloud resource according to another embodiment of the present disclosure; and

FIG. 5 is a block diagram of an auction system for an allocation of a mobile cloud resource according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation. In addition, terms such as “first” and “second” are used herein for purposes of description and are not intended to indicate or imply relative importance or significance.

In the description of the present disclosure, unless specified or limited otherwise, it should be noted that, terms “mounted,” “connected” and “coupled” may be understood broadly, such as electronic connection or mechanical connection, inner communication between two elements, direct connection or indirect connection via intermediary. These having ordinary skills in the art should understand the specific meanings in the present disclosure according to specific situations.

Referring to the following descriptions and drawings, these and other aspects of the embodiments of the present disclosure will be apparent. In these descriptions and drawings, some specific approaches of the embodiments of the present disclosure are provided, so as to show some ways to perform the principle of the embodiments of the present disclosure, however it should be understood that the embodiment of the present disclosure is not limited thereby. Instead, the embodiments of the present disclosure comprise all the variants, modifications and their equivalents within the spirit and scope of the present disclosure as defined by the claims.

An auction method and system for an allocation of a mobile cloud resource according to embodiments of the present disclosure will be described in the following with reference to drawings.

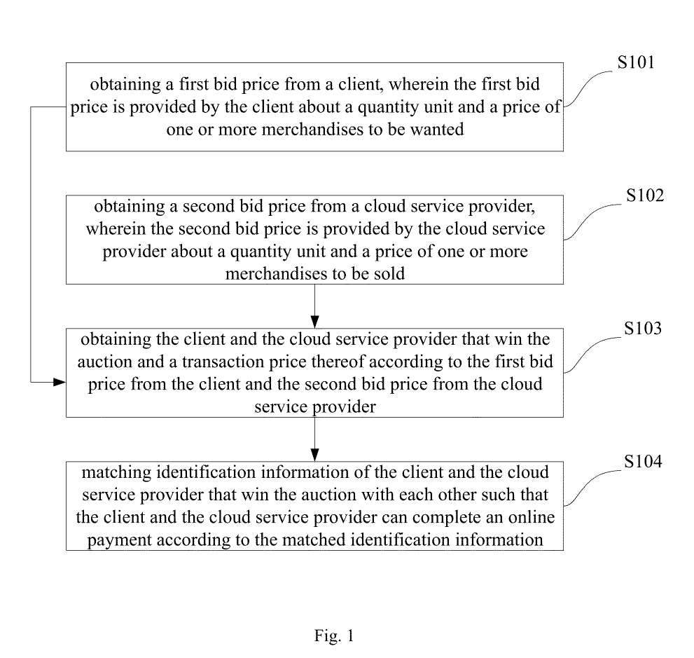

FIG. 1 is a flow chart of an auction method for an allocation of a mobile cloud resource according to an embodiment of the present disclosure. As shown in FIG. 1, the auction method for an allocation of a mobile cloud resource according to an embodiment of the present disclosure includes following steps.

At step S101, a first bid price from a client is obtained, in which the first bid price is provided by the client about a quantity unit and a price of one or more merchandises to be wanted.

At step S102, a second bid price from a cloud service provider is obtained, in which the second bid price is provided by the cloud service provider about a quantity unit and a price of one or more merchandises to be sold.

In an embodiment of the present disclosure, the client provides the first bid price for the quantity unit and the price of one or more merchandises to be wanted according to a predetermined auction language.

Specifically, if the merchandises intended to be wanted are a group of merchandises with independent or complementary efficiencies and a required quantity of the each kind of merchandises is one unit, the client inputs (<S,v^{S}>) via the predetermined auction language to indicate that the client intents to purchase one unit of each kind of merchandises in a merchandise to be wanted set S with a total cost v^{S}, i.e., it is an atom bid of the client (such as the mobile user).

If the merchandises intended to be wanted are the group of merchandises with independent or complementary efficiencies and the required quantity of the each kind of merchandises is at least one unit, in which n is an integer larger than one, the client inputs (<S,v^{S}>)^{≦n} via the predetermined auction language to indicate that the client intents to purchase one to n units of the each kind of merchandises in the set S respectively in which a total cost of one unit of the each kind of merchandises in the set S is v^{S}, i.e., it is a multi-unit atom bid of the client.

If the merchandises intended to be wanted are a group of merchandises with substitutable efficiencies and a required quantity of the each kind of merchandises is one unit, the client inputs (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, i.e., it is a combinatorial bid, in which S₁∩S₂=Ø (i.e., the merchandise in S₁ is not identical with that in S₂).

If the merchandises intended to be wanted are the group of merchandises with substitutable efficiencies and the required quantity of the each kind of merchandises is at least one unit, in which n is an integer larger than one, the client inputs (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, i.e., it is a multi-unit combinatorial bid, in which S₁∩S₂=Ø (i.e., the merchandise in S₁ is not identical with that in S₂).

Furthermore, the method further includes a following step (not shown in Fig. X): a price lower limit of the client is set in the auction, and the first bid price of each merchandise from the client is larger than the price lower limit, which improves an efficiency of the auction and avoids a too low first bid price from the client, thus ensuring the transaction fairness, and the price lower limit of the client is adjustable according to a previous deal record.

In addition, the method further includes a following step (not shown in Fig. X): a price upper limit of the cloud service provider is set in the auction, and the second bid price of each merchandise from the cloud service provider is less than the price upper limit, which improves the efficiency of the auction and avoids a too high second bid price from the cloud service provider, thus ensuring the transaction fairness, and the price upper limit of the cloud service provider is adjustable according to the previous deal record.

At step S103, the client and the cloud service provider that win the auction and a transaction price thereof are obtained according to the first bid price from the client and the second bid price from the cloud service provider.

Specifically, a winner determination model is established according to the first bid price and the second bid price in purpose of maximizing an overall revenue of the client and the cloud service provider, and with reference to Lagrangian relaxation decomposition and a sub-gradient algorithm, the winner determination model is solved to obtain the client and the cloud service provider that win the auction and the transaction price thereof in predetermined iteration scope.

At step S104, identification information of the client and the cloud service provider that win the auction is matched with each other such that the client and the cloud service provider can complete an online payment according to the matched identification information.

Specifically, the identification information of the client and the cloud service provider that win the auction is matched to find the client and cloud service corresponding to each other and a final result of the auction is published on a bulletin board, such that the client can complete an online payment provided by the corresponding cloud service provider.

Moreover, the method according to embodiments of the present disclosure further includes a following step before step S101 and S102 (not shown in Fig. X): applications for taking part in the auction from the client and the cloud service provider are received respectively; and an authentication and an examination are taken to complete an online registration for the client and the cloud service provider respectively such that the client and the cloud service provider distribute auction information online.

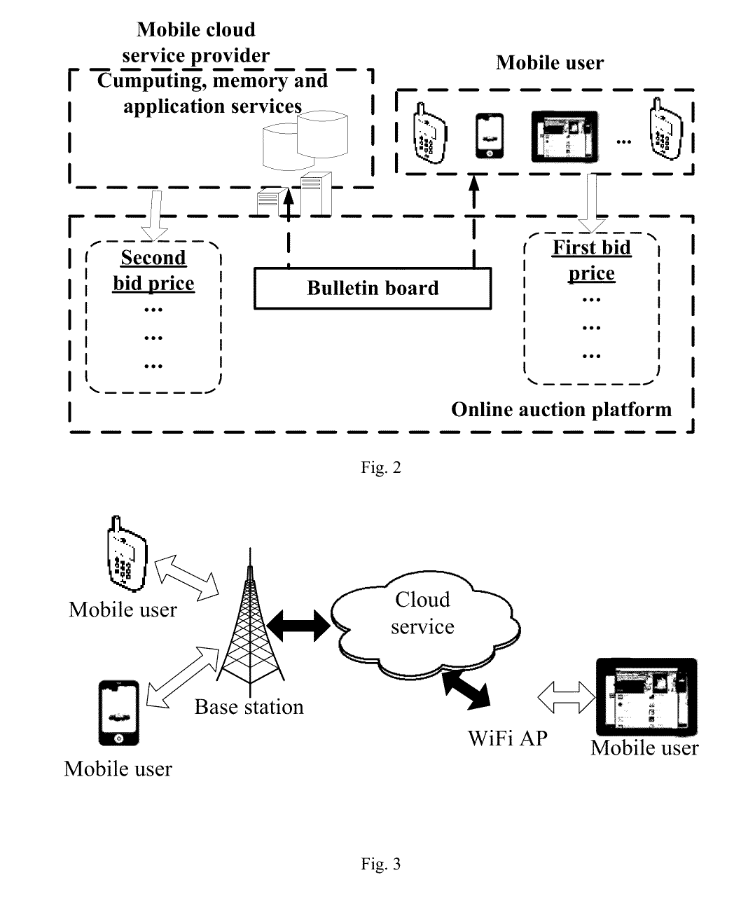

In an embodiment of the present, as shown in FIG. 2, the client (i.e., the buyer such as the mobile user) and the cloud service provider (i.e., the seller such as the computing, memory and application service provider) are registered, authenticated and examined online. In the auction, the buyer and the seller have an opportunity to submit their bid price, in which the client provides the first bid price about the quantity unit and the price of one or more merchandises to be wanted according to the predetermined auction language, and the cloud service provider provides the second bid price about the quantity unit and the price of one or more merchandises to be sold according to an auction rule. In a winner determination state, the winner determination model is established according to the first bid price and the second bid price in purpose of maximizing the overall revenue of the client and the cloud service provider, and the winner determination model is decomposed with reference to the Lagrangian relaxation decomposition and is further solved according to the sub-gradient algorithm, so as to obtain the client and the cloud service provider that win the auction and the transaction price thereof in predetermined iteration scope. Finally, the result of the auction is published on the bulletin board and the online payment between the client and the cloud service provider is completed.

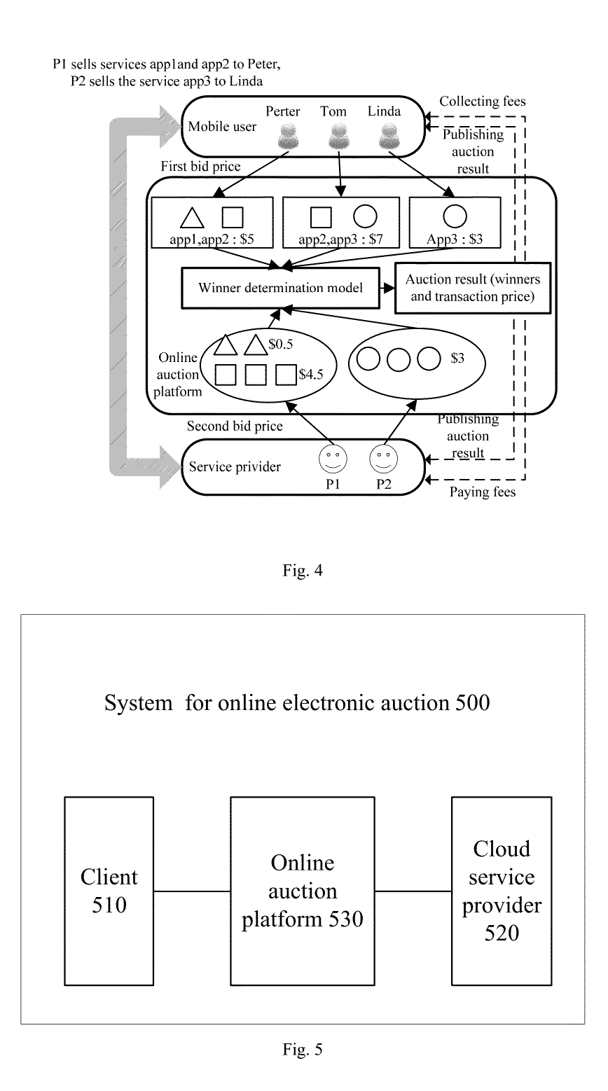

The auction method for an allocation of a mobile cloud resource according to embodiments will be further described in detail with reference to FIGS. 3 and 4.

FIG. 3 is a schematic diagram of a scene in which a client uses a cloud service according to an embodiment of the present disclosure. Specifically, the method according to embodiments of the present disclosure introduces a combinatorial auction and a double auction into the mobile cloud computing market allocation for the first time, which satisfies the requirement of the mobile cloud market and provides high market efficiency.

Characteristics of the mobile cloud market are shown as following: there are various kinds of merchandises and all the merchandises (including the computing, memory and application services) can be traded online After the mobile user buys the merchandise, the corresponding service can be used through the wireless network (such as the mobile access network, the wireless local area network such as WiFi).

As shown in FIG. 3, after buying a corresponding cloud service, the user can send some computing requests to a cloud to execute or store some documents in the cloud, which makes up for the insufficiencies of the computing property, the memory and the battery of the mobile terminal. Therefore, it is very important for an online electronic auction platform to complete the transaction for the mobile user quickly and conveniently.

For the mobile user (i.e., the client), a plurality of cloud services usually are needed. For example, when a right of using a 1 GB storage space to store images for one year is bought, a corresponding wireless broadband network usually is needed to buy and sometimes an image processing service also is needed, such as an animation production service. The combinatorial auction allows the user to bid for a combination of merchandises, otherwise it is required for the user to break up his budget so as to take part in a plurality of sequential auctions. For example, a mobile user Peter needs to buy two services app1 and app2 and would like to pay 5 dollars for them. In the combinatorial auction, Peter may bundles the two services together to make a bid price. On the contrary, if there is not the combinatorial auction, Peter has to break up his budget to take part in auctions of the two services app1 and app2 respectively, and thus the cost is increased and more importantly, it is difficult to break up the budget. If the plurality of merchandises to be bought by the user at the same time are complementary, i.e., only bought at the same time, can the plurality of merchandises play their roles, it is not sure whether the plurality of merchandises can be bought at the same time by taking part in different sequential auctions of the merchandises. In addition, the combinatorial auction allows the user to bid for the substitute merchandises. For example, if Peter can obtain a same function with that of the services app1 and app2 by buying another two services app3 and app4, he can provide a combinatorial bid price such as (app1 and app2) or (app3 and app4) with a total budget of 5 dollars, in case that a bid for four services in the auction at the same is permitted.

Based on above characteristics, the combinatorial auction is more suitable for the mobile user to buy the cloud services which are various and complementary or substitutable with each other, and thus the combinatorial auction is introduced into the method for the online electronic auction according to embodiments of the present disclosure. Moreover, in the combinatorial auction, the seller and buyer are allowed to bid at the same time, which makes the transaction flexible and provides high efficiency. A double auction is an auction mechanism with respect to the one-way auction. In the one-way auction, one seller corresponds to a plurality of buyers or one buyer corresponds to a plurality of sellers, and one side of the buyer and seller monopolizes the resources in the market. Therefore, the one-way auction usually has following defects: (1) the buyer makes a bid price frequently, which increases a network burden and wastes the network resource; (2) a long transaction time is set, which reduces the transaction efficiency and increases the cost of the electronic commerce; (3) an unfair competition is caused and the satisfaction of the user is reduced. On the contrary, in the double auction, a plurality of sellers and a plurality of buyers conduct a transaction at the same time, and the seller and the buyer have an equal relationship therebetween, i.e., an information communication network model of equality between the seller and the buyer. Therefore, the double auction is introduced into the method according to embodiments of the present disclosure.

As shown in FIGS. 2 and 3, the mobile user and the cloud service provider can visit the platform through the internet and take part in the auction after being registered as users. In each auction, the online auction platform serves as an auctioneer, who takes the authentication and the examination on the seller and the buyer and publishes the merchandise information before the auction, and publishes the bid prices of the seller and the buyer and makes the winner determination in the auction, and finally publishes the result of the auction and monitors the implementation of the transaction. Due to the combinatorial auction, the mobile user can bid for a combination of merchandises at the same time; due to the double auction, not only the plurality of mobile users can make a bid price, but also can the plurality of service providers make a bid price of their merchandises at the same time.

In an embodiment of the present disclosure, in order to ensure the efficiency and fairness of the auction, following auction rules are made.

Rule 1: a constant biding period t_{bp} is set. In the constant biding period t_{bp}, the mobile user and the service provider only can provide their bid prices once. After the auction, the bid prices and the transaction matching result will be published.

Rule 2: the mobile user can provide the first bid price for one or a group of merchandises in a predetermined language which is denoted as:

Bᵢ=L_{MU}(<S,vᵢ^{S}>)

where S is a set of merchandise to be wanted; vᵢ^{S} is a total cost of the merchandise to be wanted in S; L_{MU} is the predetermined auction language used by the mobile user to provide the first bid price.

Rule 3: the cloud service provider makes the second bid price about one or more merchandises, which may be denoted as:

Aⱼ=(<r₁,cⱼ^{r}^{₁},gⱼ^{r}^{₁}>, . . . ,<rₖ,cⱼ^{r}^{ₖ},qⱼ^{r}^{ₖ}>, . . . ,<rₘ,cⱼ^{r}^{ₘ},qⱼ^{r}^{ₘ}>)

where each triple represents a merchandise provided by the cloud service provider and its price and quantity.

Rule 4: in order to improve the efficiency of the auction and to avoid a too low first bid price, a price lower limit Bₘᵢₙ of the client is set. The first bid price of each merchandise from the client is larger than the price lower limit Bₘᵢₙ, i/e., vᵢ^{S}/|S|≧Bₘᵢₙ, and the price lower limit Bₘᵢₙ of the client is adjustable according to a previous deal record and is published by the platform at the beginning of the auction, and a default value of price lower limit Bₘᵢₙ is zero.

Rule 5: in order to improve the efficiency of the auction and to avoid a too high the second bid price, a price upper limit Aₘₐₓ of the cloud service provider is set. The second bid price of each merchandise from the cloud service provider is less than the price upper limit Aₘₐₓ, i/e., cⱼ^{r}^{ₖ}≦Aₘₐₓ, and the price upper limit Aₘₐₓ of the client is adjustable according to the previous deal record and is published by the platform at the beginning of the auction, and a default value of price upper limit Aₘₐₓ is +∞.

FIG. 4 is a flow chart of an auction method for an allocation of a mobile cloud resource according to another embodiment of the present disclosure.

As shown in FIG. 4, three mobile users Peter, Tom, Linda and two cloud service provider P1 and P2 take part in the auction. In the auction, each of them has a chance to provide his bid price.

Peter needs two services app1 and app2 and would like to pay 5 dollars for them; Tom needs two services app2 and app3 and would like to pay 7 dollars for them; Linda needs one service app3 and would like to pay 3 dollars for it. In the embodiment of the present disclosure, Peter and Tom needs to buy two services and must buy the two services at the same time, and Linda only needs to buy one service. According to above auction rules in the method for the online electronic auction according to embodiments of the present disclosure, the mobile user can provide the first bid price for one or a group of merchandises by using the predetermined auction language.

The cloud service provider P1 provides the service app1 with a price of 0.5 dollars and the service app2 with a price of 4.5 dollars; the cloud service provider P2 provides the service app3 with a price of 3 dollars. According to above auction rules in the method for the online electronic auction according to embodiments of the present disclosure, the cloud service provider can make the second bid price for one or more merchandises, but must make the second bid price for each merchandise respectively.

In the auction, each of the mobile users and the cloud service providers has a chance to provide his bid price. After the auction is completed, the online auction platform matches the first bid prices of the mobile users with the second bid prices of the cloud service providers, determines the mobile users and the cloud service providers that win the auction and performs a transaction matching. As shown in FIG. 4, Peter is matched with P1 (i.e., Peter obtains the services app1 and app2 and P1 sells one piece of service app1 and one piece of service app2), Linda is matched with P2 (i.e., Linda obtains the service app3 and P2 sells one piece of service app3) and Tom fails. The online auction platform publishes the result of the auction on the bulletin board, collects the money to be paid by the mobile user that win the auction and pays the collected money to the corresponding cloud service provider.

In a following embodiment, the predetermined auction language used in the method for the online electronic auction according to embodiments of the present disclosure will be described in the following.

Specifically, in above auctions, it is a key to ensure that the mobile user can combine his requirement and budget together in a bidding manner to obtain the first bid price and files the first bid price to the online auction platform. The predetermined auction language allows the mobile user to make the first bid price for a combination of any interested merchandises and represents his preference for a specified combination of merchandises. In addition, the predetermined auction language also allows the first bid price from the mobile user to be sent to the online auction platform simply and to be processed accurately.

Furthermore, for the mobile user, each of the plurality of cloud services to be bought at the same time may have a function independent from those of others or may be used with the support of the use of others, such as an image storage space service and an image animation processing service. In addition, different merchandises may be replaced with each other, such as a flash animation production application and a GIF animation production application. In other words, for the mobile user, if a psychological price of two merchandises to be sold together is larger than a sum of the psychological prices of the two merchandise to be sold solely, the two merchandises are complementary with each other; if a psychological price of two merchandises to be sold together is less than a sum of the psychological prices of the two merchandise to be sold solely, the two merchandises are substitutable with each other. Apparently, the mobile user usually would like to buy the complementary merchandises together at the same time and only would like to buy one of the substitutable merchandises, instead of buying the substitutable merchandises together at the same time, unless the price thereof is favorable enough if the substitutable merchandises are bought together at the same time.

In embodiments of the present disclosure, the mobile user provides the first bid price according to the predetermined auction language L_{MU}, which allows the mobile user to bid for a combination of merchandises and distinguishes the complementarity from the substitutability between merchandises. A grammar paradigm of the predetermined auction language is shown as following:

BID ::= (Comb_Bid)|(Comb_Bid)^{≦n}
Comb_Bid ::= Atom_Bid|Atom_Bid→Atom_Bid
Atom_Bid ::=< S,v^{S} >

According to the grammar paradigm of the predetermined auction language, the mobile user can provide the first bid price of following types:

(1) The atom bid of the client: the merchandises intended to be wanted are a group of merchandises with independent or complementary efficiencies and a required quantity of the each kind of merchandises is one unit. The client may inputs (<S,v^{S}>) via the predetermined auction language to indicate that the client intents to purchase one unit of each kind of merchandises in a merchandise to be wanted set S with a total cost v^{S}.

(2) The multi-unit atom bid of the client: the merchandises intended to be wanted are the group of merchandises with independent or complementary efficiencies and the required quantity of the each kind of merchandises is at least one unit. The client may input (<S,v^{S}>)^{≦n} via the predetermined auction language to indicate that the client intents to purchase one to n units of each kind of merchandises in the set S respectively in which a total cost of one unit of the each kind of merchandises in the set S is v^{S}.

(3) The combinatorial bid of the client: the merchandises intended to be wanted are a group of merchandises with substitutable efficiencies and a required quantity of the each kind of merchandises is one unit. The client may input (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}.

(4) The multi-unit combinatorial bid of the client: the merchandises intended to be wanted are the group of merchandises with substitutable efficiencies and the required quantity of the each kind of merchandises is at least one unit. The client may input (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}.

Currently, there is an OR auction language, a XOR auction language and an OR-XOR mixed auction language for the combinatorial auction. The OR auction language can be used to make a bid for a combination of complementary merchandises, but cannot be used to make a bid price for a combination of substitutable merchandises. The XOR auction language can be used to make a bid price for a combination of substitutable merchandises, but more complex than the OR auction language. Therefore, the OR-XOR mixed auction language is produced, but complex to use for a common mobile user, and thus it is not suitable for popularization.

The predetermined auction language L_{MU} according to embodiments of the present disclosure can present a same meaning as the OR auction language in a simpler manner as following:

$${Bid}^{\leq n} ⇔ \underbrace{( Bid OR Bid OR … OR Bid )}_{n} .$$

When the mobile user makes the first bid price for a plurality of units of merchandises, it indicates that the mobile user may obtain one to n units of merchandises. This is denoted as

$$\underbrace{( Bid OR Bid OR … OR Bid )}_{n}$$

in the OR auction language, but as Bid^{≦n} in the predetermined auction language L_{MU}, which is simpler. In addition, the predetermined auction language L_{MU} according to embodiments of the present disclosure also can present a same meaning as the XOR auction language as following:

(<S₁,v^{S}^{₁}>→<S₂,v^{S}^{₂}>) [symbol] (<S₁,v^{S}^{₁}>XOR<S₁∪S₂,v^{S}^{₂}>)

where the mobile user indicates that the merchandises S₁ and S₂ are substitutable.

Moreover, since the predetermined auction language L_{MU} is more flexible and simpler than the OR and XOR languages, a cost of transmitting the first bid price on the Internet is low (i.e. a content of transmitting is few), in which the first bid price is provided by the mobile user according to the predetermined auction language L_{MU}.

In conclusion, the predetermined auction language L_{MU} according to embodiments of the present disclosure has following advantages:

(1) The predetermined auction language L_{MU} is easy to use, provides four types of bidding manners and has a simple grammar, which satisfies the bid requirement of the mobile user without introducing complex logic and symbols.

(2) The predetermined auction language L_{MU} can presents the requirement that the mobile user wants to buy a plurality of units of a combination of merchandises.

(3) The predetermined auction language L_{MU} has a more complete and accurate semanteme, compared with the OR and the XOR languages.

(4) The first bid price presented in the predetermined auction language L_{MU} is simple and includes a small number of symbols, which can be transmitted by the wireless network quickly, thus satisfying the requirement of the mobile user and reducing the network transmission cost.

In a following exemplary embodiment, a method for a winner determination in a method for an online auction platform according to embodiments of the present disclosure will be described in detail.

With the method according to embodiments of the present disclosure, in the combinatorial and double auction, the final result of the transaction is calculated by using the method for the winner determination. How to match the first bid prices of the plurality of the buyers and the second bid prices of the plurality of the sellers is the key to determine the transaction profit and the market efficiency, and this also is one basic problem of the combinatorial auction—Winner Determine Problem (WDP), also known as CAP (Combinatorial Allocation Problem).

The current winner determination model of the combinatorial auction is for the one-way auction and is in the purpose of maximizing the profit of the biding party. Since the method according to embodiments of the present disclosure introduces the combinatorial auction and the double auction, the current winner determination model cannot be used, and thus the winner determination model of the method according to embodiments of the present disclosure is designed for the mobile cloud market in purpose of maximizing the profits of the seller and the buyer. Moreover, a specified solving method is provided for the winner determined model, and thus the online auction platform can implement a transaction matching between the seller and the buyer based on the winner determination model and the corresponding solving method.

Furthermore, since the mobile user can make the first bid price in four manners by using the predetermined auction language, the cloud service provider also can make the second bid price including prices of various merchandises. In order to simplify the winner determination problem, a sub-user, a virtual merchandise, a virtual provider and a sub-provider are introduced to simplify the first bid price from the mobile user and the second bid price from the cloud service provider. A corresponding simplifying method is shown as following.

(1) The multi-unit atom bid price in the form of (<S,v^{S}>)^{≦n} may be converted into n atom bid prices (<S,v^{S}>), which are supposed to be provided by n sub-users respectively.

(2) The one-unit combinatorial bid price in the form of (<S₁,v^{S}^{₁}>→<S₂,v^{S}^{₂}>) may be converted into two atom bid prices (<S₁∀{dummyᵢ},v^{S}^{₁}>) and (<S₁∪S₂∪{dummyᵢ},v^{S}^{₂}>) by introducing a virtual merchandise dummyᵢ, which are supposed to be provided by two sub-users respectively, and also a virtual provider dpᵢ is needed to be introduced to sell the virtual merchandise dummyᵢ.

(3) A multi-unit combinatorial bid price in the form of (<S₁,v^{S}^{₁}>→<S₂,v^{S}^{₂}>)^{≦n} may be converted into 2×n atom bid prices (<S₁∪{dummyᵢ¹},v^{S}^{₁}>), (<S₁∪S₂∪{dummyᵢ¹},v^{S}^{₂}>), . . . ,(<S₁∪{dummy₁ⁿ},v^{S}^{₁}>), (<S₁∪S₂∪{dummyᵢⁿ},v^{S}^{₂}>) by introducing n virtual merchandises {dummyᵢ¹, . . . dummyᵢⁿ}, which are supposed to be provided by 2×n sub-users, and also n virtual providers {dpᵢ¹, . . . ,dpᵢⁿ} are needed to be introduced and each virtual provider sells one virtual merchandise.

(4) The second bid price of the cloud service provider in the form of (<r₁,cⱼ^{r}^{₁},qⱼ^{r}^{₁}>, . . . ,<rₖ,cⱼ^{r}^{ₖ},qⱼ^{r}^{ₖ}; >, . . . ,<rₘ,cⱼ^{r}^{ₖ},qⱼ^{r}^{ₘ}>) may be broken up into m bid prices, and each bid price only includes one merchandise, and m sub-providers are supposed to provide the m bid prices respectively.

According to above four conversions, all the first bid prices of the mobile users are converted into atom bid prices, and all the second bid prices of the cloud service providers are converted into bid prices of which each only includes one merchandise, and then an optimal transaction matching can be calculated by using the winner determination model. Successful transactions of the sub-users and the sub-providers are combined together to obtain the successful transaction information of the original mobile user and cloud service provider. By conversions, following sets are produced: a set of merchandises \hat{R} including the original merchandises and the introduced virtual merchandises; a set of mobile users i.e. clients Î and a set of cloud service providers Ĵ; a set of first bid prices \hat{B} and a set of second bid prices Â. Based on the simplified auction information, the winner determination model is denoted as formula (1):

$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ \hat{{B}_{i} ( 1 )}} {x}_{i} = {\sum }_{j ∈ \hat{J} , r = {\hat{A}}_{j} ( 1 )} {y}_{j} \text{∀} r ∈ \hat{R} \\ {y}_{j} ∈ \{ 0 , 1 , … , {q}_{j} \} \text{∀} j ∈ \hat{J} \\ {x}_{i} ∈ \{ 0 , 1 \} \text{∀} i ∈ \hat{I} \qquad ( 1 )$$

where xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; \hat{R} is a merchandise set; B_{î}(1) is a set of first bid price accepted by the i^{th} client; A_{ĵ}(1) is a set of second bid price accepted by the j^{th} cloud service provider.

The utility function Uᵢ(Sᵢ) of the i^{th} client may be obtained according to formula (2):

$${U}_{i} ( {S}_{i} ) = {v}_{i}^{S} - {\sum }_{r ∈ S} {P}_{i}^{r} \qquad ( 2 )$$

where S is a set of merchandises to be wanted, vᵢ^{S} is a total cost of merchandises in S in the first bid price of the i^{th} client,

$${\sum }_{r ∈ S} {P}_{i}^{r}$$

is an actual transaction price of merchandises in S. The utility function represents satisfaction of the buyer of buying this group of merchandises, and is a price from the first bid price subtracting the actual transaction price.

The revenue function of the j^{th} cloud service provider may be obtained according to formula (3):

Wⱼ(rⱼ)=Pⱼ^{r}−cⱼ^{r} (3)

where Pⱼ^{r} is an actual transaction price of the r^{th} merchandise of the j^{th} cloud service provider, cⱼ^{r} is a second bid price of the r^{th} merchandise of the j^{th} cloud service provider. The revenue function represents profit of the seller for selling one merchandise, and is a price from the actual transaction price subtracting the second bid price.

Then, according to formula (2) and formula (3), formula (1) is simplified into formula (4):

$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 \text{∀} r ∈ \hat{R} \\ {y}_{j} ∈ \{ 0 , 1 , … , {q}_{j} \} \text{∀} j ∈ \hat{J} \\ {x}_{i} ∈ \{ 0 , 1 \} \text{∀} i ∈ \hat{I} \qquad ( 4 )$$

where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element aᵣⱼ in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0).

In order to solve above problems, the winner determination model is decomposed with reference to the Lagrangian relaxation decomposition and is further solved according to the sub-gradient algorithm, so as to obtain an optimal solution of the goal question in predetermined iteration scope.

Specifically, a Lagrangian relaxation factor λ is introduced into formula (4) to obtain formula (5):

z_{LR}(λ)=max L(x,y;λ)

s.t. 0≦yⱼ≦qⱼ∀jεĴ

0≦xᵢ≦1∀iεÎ (5)

where

$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) , L D$$

is a dual problem of the winner determination problem IP.

Further, the dual problem LD of the winner determination problem IP may be obtained according to formula (6):

z_{LD}=min z_{LR}(λ)

s.t. λᵣ≧0∀rε\hat{R} (6)

The above dual problem LD, which may be seen as a travelling salesman problem, can be solved by a sub-gradient algorithm to obtain the client and the cloud service provider that win the auction and the transaction price thereof in a predetermined iteration scope, in which a sub-gradient is denoted as formula (7):

g=∂L(x,y;λ)/∂λ (7)

Furthermore, in each iteration, the Lagrangian relaxation factor λ is changed along a direction of the sub-gradient according to formula (8):

λ^{(k+1)}=λ^{(k)}+t^{(k)}g^{(k)} (8),

where t^{(k)} is an iterative step and g^{(k)} is a sub-gradient of each iteration.

In addition, a threshold ε is preset. After a plurality of iterations, if g^{(k)}≦ε, the iteration is stopped, and then the optimal solution of the dual problem LD of the winner determination problem IP is obtained, i.e., an optimal solution of the original problem also is obtained, which also is the matching result of the mobile user and the cloud service provider in the combinatorial and double auction. Certainly, the result is for the simplified winner determination model, and the successful transaction information of the original mobile user and cloud service provider can be obtained by combining the successful transaction of the sub-user and the sub-provider.

In an embodiment of the present disclosure, a process of solving the winner determination model of the mobile cloud resource is provided as following.

Input:
1) a set of merchandises \hat{R}, a set of mobile users Î and a set of cloud service providers Ĵ;
2) a set of first bid prices B={B₁, . . . Bᵢ, . . . B_{|I|}} and a set of second bid prices A={A₁, . . . Aⱼ, . . . A_{|J|}}.

Output:
1) a transaction result: a vector quantity WB which represents whether the first bid price of the mobile user has won, a vector quantity WB which represents whether the merchandise of the cloud service provider has been sold;
2) a transaction price of each merchandise: P={P₁, . . . Pᵣ, . . . P_{|R|}}.

/* stage 1: a pre-processing, in which a virtual merchandise in introduced, the first bid price from the mobile user is converted into atom bids and the second bid price from the cloud service provider is convert into bid prices only including one merchandise*/

| | |
|---|---|
| 1: | Initialize Î,Ĵ,\hat{B},Â = Ø,\hat{R} = R |
| 2: | For all Bᵢ ε B do |
| 3: | If Bᵢ is not an atom bid, then |
| 4: | convert Bᵢ into a series of atom bids S_{b}, and also produce a |

series of sub-users suᵢ, a series of virtual merchandises dummyᵢ and a
series of virtual providers dpᵢ

| | |
|---|---|
| 5: | \hat{B} = \hat{B}∪S_{b},Î = Î∪suᵢ |
| 6: | For all dummyᵢⁿ ε dummyᵢ do |
| 7: | Ĵ = Ĵ∪dpᵢⁿ,Â = Â∪{(<dummyᵢⁿ,0,1>)},\hat{R} = \hat{R}∪{dummyᵢⁿ} |
| 8: | End For |
| 9: | Else |
| 10: | \hat{B} = \hat{B}∪Bᵢ,Î = Î∪{userᵢ} |
| 11: | End If |
| 12: | End For |
| 13: | For all Aⱼ ε A do |
| 14: | If \| Aⱼ \|≧1, then |
| 15: | convert Aⱼ into a series of bid prices Sₐ only including one |

merchandise, and also produce a series of sub-providers spⱼ

| | |
|---|---|
| | Â = Â∪Sₐ,Ĵ = Ĵ∪spⱼ |
| 16: | Else |
| 17: | Â = Â∪Aⱼ,Ĵ = Ĵ∪{providerⱼ} |
| 18: | End If |
| 19: | End For |
| 20: | Construct 0-1 matrixes a and b, and obtain an optimization problem LP |

/* stage 2: solving the optimization problem LP*/

| | |
|---|---|
| 21: | Introduce a Lagrangian relaxation factor λ to obtain a dual problem LD |

of the optimization problem LP

| | |
|---|---|
| 22: | Initialize k = 1,λ⁽¹⁾ = (1,...1),g⁽¹⁾,ε > 0 |
| 23: | Where g^{(k)}≧ε do |
| 24: | calculate x^{(k)},y^{(k)},t^{(k)} = ( L̅-L(x^{(k)},y^{(k)};λ^{(k)}))/ \|\|g^{(k)} \|\|² |
| 25: | λ^{(k+1)} =λ^{(k)}+t^{(k)}g^{(k)} |
| 26: | k=k+1 |
| 27: | End Where |

/* stage 3: converting the optimal solution into the solution of the original
problem*/

| | |
|---|---|
| 28: | Delete the transaction price of the virtual merchandise, P = {λ₁,...λ_{\|R\|}} |
| 29: | For r=1 to \|R\| do |
| 30: | gather the successful transaction result of the sub-user and the |

sub-provider into the successful transaction result of the
original mobile user and cloud service provider, and obtain WB and WA

| | |
|---|---|
| 31: | End For |

Since the Lagrangian relaxation factor

$$λ = \{ {λ}_{1} , … {λ}_{\hat{\vert R \vert}} \}$$

is a |\hat{R}|-Dimensional vector, a first constraint condition to relax the original problem is that a number of the merchandises won by the mobile user cannot be larger than that of the merchandises provided by the cloud service provider. From the point of micro-economics, λ is an impact factor configured to adjust the relation between supply and demand, and when the optimal solution is obtained after the plurality of iterations, λ may be treated as the actual transaction price.

In conclusion, a satisfied optimal solution can be obtained in the predetermined iteration scope with the method according to embodiments of the present disclosure, and it is proved that the optimal solution satisfying corresponding requirements still can be obtained after a finite iteration with increase of the scale of the auction.

With the auction method for an allocation of a mobile cloud resource according to embodiments of the present disclosure, the client (i.e. the buyer) provides the first bid price about the quantity unit and the price of one or more merchandises to be wanted, and the could service provider (i.e. the seller) provides the second bid price about the quantity unit and the price of one or more merchandises to be sold; in the winner determination stage, the online auction platform obtains the client and the cloud service provider that win the auction and the transaction price thereof according to the first bid price and the second bid price; finally, the online platform matches identification information of the client and the cloud service provider that win the auction with each other, such that the corresponding client and the cloud service provider completes the online payment according to the matched identification information. Therefore, the client (i.e. the buyer) and the cloud service provider (i.e. seller) can provide a bid price at the same time, and also can bid for and sell a combination of merchandises respectively, which implements a reasonable allocation and a price fixing of the mobile cloud resource, and thus the method has great flexibility and high market efficiency.

Embodiments of the present disclosure further provide an auction system for an allocation of a mobile cloud resource.

FIG. 5 is a block diagram of an auction system for an allocation of a mobile cloud resource according to an embodiment of the present disclosure. As shown in FIG. 5, the system 500 includes: a client 510, a cloud service provider 520 and an online electronic platform 530.

The client 510 is a buyer in the auction, such as a mobile user, and is configured to provide a first bid price about a quantity unit and a price of one or more merchandises to be wanted.

The cloud service provider 520 is a seller in the auction, such as a cloud service provider, and is configured to provide services for the buyer and to provide a second bid price about a quantity unit and a price of one or more merchandises to be sold.

The online auction platform 530 is configured to obtain the client 510 and the cloud service provider 520 that win the auction and a transaction price thereof according to the first bid price from the client 510 and the second bid price from the cloud service provider 520 and to match identification information of the client 510 and the cloud service provider 520 that win the auction with each other such that the client 510 and the cloud service provider 520 can complete an online payment according to the matched identification information.

In addition, the online auction platform 530 is further configured to receive an application for taking part in the auction from the client 510 and the cloud service provider 520 respectively, and to take an authentication and an examination to complete an online registration for the client 510 and the cloud service provider 520 respectively such that the client 510 and the cloud service provider 520 can distribute auction information online.

In an embodiment of the present disclosure, if the merchandises intended to be wanted are a group of merchandises with independent or complementary efficiencies and a required quantity of the each kind of merchandises is one unit, the client 510 inputs (<S,v^{S}>) via the predetermined auction language to indicate that the client 510 intents to purchase one unit of each kind of merchandises in a merchandise to be wanted set S with a total cost v^{S}, i.e., it is an atom bid of the client 510 (such as the mobile user).

If the merchandises intended to be wanted are the group of merchandises with independent or complementary efficiencies and the required quantity of the each kind of merchandises is at least one unit, in which n is an integer larger than one, the client 510 inputs (<S,v^{S}>)^{≦n} via the predetermined auction language to indicate that the client 510 intents to purchase one to n units of the each kind of merchandises in the set S respectively in which a total cost of one unit of the each kind of merchandises in the set S is v^{S}, i.e., it is a multi-unit atom bid of the client 510.

If the merchandises intended to be wanted are a group of merchandises with substitutable efficiencies and a required quantity of the each kind of merchandises is one unit, the client 510 inputs (<S₁,v^{S}^{₁}>→<S₂,v^{S}^{₂}>) via the predetermined auction language to indicate that the client 510 intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, i.e., it is a combinatorial bid, in which S₁∩S₂=Ø (i.e., the merchandise in S₁ is not identical with that in S₂).

If the merchandises intended to be wanted are the group of merchandises with substitutable efficiencies and the required quantity of the each kind of merchandises is at least one unit, in which n is an integer larger than one, the client 510 inputs (<S₁,v^{S}^{₁}>→<S₂,v^{S}^{₂}>)^{≦n} via the predetermined auction language to indicate that the client 510 intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, i.e., it is a multi-unit combinatorial bid, in which S₁∩S₂=Ø (i.e., the merchandise in S₁ is not identical with that in S₂).

Furthermore, the online auction platform 530 is further configured to set a price lower limit of the client 510 in the auction, and the first bid price of each merchandise from the client 510 is larger than the price lower limit, which improves an efficiency of the auction and avoids a too low first bid price from the client 510, thus ensuring the transaction fairness, and the price lower limit of the client 510 is adjustable according to a previous deal record.

In addition, the online auction platform 530 is further configured to set a price upper limit of the cloud service provider 520 in the auction, and the second bid price of each merchandise from the cloud service provider 520 is less than the price upper limit, which improves the efficiency of the auction and avoids a too high second bid price from the cloud service provider 520, thus ensuring the transaction fairness, and the price upper limit of the cloud service provider 520 is adjustable according to the previous deal record.

In an embodiment of the present disclosure, the online auction platform 530 is configured to establish a winner determination model according to the first bid price and the second bid price in purpose of maximizing an overall revenue of the client 510 and the cloud service provider 520, and to solve the winner determination model to obtain the client 510 and the cloud service provider 520 that win the auction and the transaction price thereof in predetermined iteration scope, with reference to Lagrangian relaxation decomposition and a sub-gradient algorithm.

Specifically, the winner determination model is denoted as:

$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ {B}_{i} ( 1 )} {x}_{i} = {\sum }_{j ∈ \hat{J} , r = \hat{{A}_{j}} ( 1 )} {y}_{j} ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 1 )$$

where Î is a set of clients; Ĵ is a set of cloud service providers; xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; R is a merchandise set; B_{î}(1) is a set of first bid price accepted by the i^{th} client; A_{ĵ}(1) is a set of second bid price accepted by the j^{th} cloud service provider.

In addition, the online auction platform is further configured to:

obtain the utility function of the i^{th} client according to formula (2),

$${U}_{i} ( {S}_{i} ) = {v}_{i}^{S} - {\sum }_{r ∈ S} {P}_{i}^{r} \qquad ( 2 )$$

where S is a set of merchandises to be wanted, vᵢ^{S} is a total cost of merchandises in S in the first bid price of the i^{th} client,

$${\sum }_{r ∈ S} {P}_{i}^{r}$$

is an actual transaction price of merchandises in S;

obtain the revenue function of the j^{th} cloud service provider according to formula (3),

Wⱼ(rⱼ)=Pⱼ^{r}−cⱼ^{r} (3)

where Pⱼ^{r} is an actual transaction price of a r^{th} merchandise of the j^{th} cloud service provider, cⱼ^{r} is a second bid price of the r^{th} merchandise of the j^{th} cloud service provider;

simplify formula (1) into formula (4) according to formula (2) and formula (3):

$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 4 )$$

where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element a, in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0);

introduce a Lagrangian relaxation factor λ into formula (4) to obtain formula (5):

z_{LR}(λ)=max L(x,y;λ)

s.t. 0≦yⱼ≦qⱼ∀jεĴ

0≦xᵢ≦1∀iεÎ (5)

where

$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) , L D$$

presents a dual problem of the winner determination problem IP;

obtain the dual problem LD of the winner determination problem IP according to formula (6),

z_{LD}=min z_{LR}(λ)

s.t. λᵣ≧0∀rε\hat{R} (6)

solve the dual problem LD by a sub-gradient algorithm to obtain the client and the cloud service provider that win the auction and the transaction price thereof in a predetermined iteration scope, where a sub-gradient is denoted as formula (7),

g=∂L(x,y;λ)/∂λ (7)

in which in each iteration, the Lagrangian relaxation factor λ is changed along a direction of the sub-gradient according to formula (8),

λ^{(k+1)}=λ^{(k)}+t^{(k)}g^{(k)} (8),

where t^{(k)} is an iterative step, g^{(k)} is a sub-gradient of each iteration.

With the auction system for an allocation of a mobile cloud resource according to embodiments of the present disclosure, the client (i.e. the buyer) provides the first bid price about the quantity unit and the price of one or more merchandises to be wanted, and the could service provider (i.e. the seller) provides the second bid price about the quantity unit and the price of one or more merchandises to be sold; in the winner determination stage, the online auction platform obtains the client and the cloud service provider that win the auction and the transaction price thereof according to the first bid price and the second bid price; finally, the online platform matches identification information of the client and the cloud service provider that win the auction with each other, such that the corresponding client and the cloud service provider completes the online payment according to the matched identification information. Therefore, the client (i.e. the buyer) and the cloud service provider (i.e. seller) can provide a bid price at the same time, and also can bid for and sell a combination of merchandises respectively, which implements a reasonable allocation and a price fixing of the mobile cloud resource, and thus the method has great flexibility and high market efficiency.

According to an embodiment of the present disclosure, a non-transit computer-readable storage medium is provided. The non-transit computer-readable storage medium includes a computer program for executing the auction method for an allocation of a mobile cloud resource described above when running on a computer.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, substitutables, and modifications can be made in the embodiments without departing from spirit, principles and scope of the present disclosure.

What is claimed is:

1. An auction method for an allocation of a mobile cloud resource, comprising:
obtaining a first bid price from a client, wherein the first bid price is provided by the client about a quantity unit and a price of one or more merchandises to be wanted;
obtaining a second bid price from a cloud service provider, wherein the second bid price is provided by the cloud service provider about a quantity unit and a price of one or more merchandises to be sold;
obtaining the client and the cloud service provider that win the auction and a transaction price thereof according to the first bid price from the client and the second bid price from the cloud service provider; and
matching identification information of the client and the cloud service provider that win the auction with each other such that the client and the cloud service provider can complete an online payment according to the matched identification information.

2. The method according to claim 1, wherein obtaining the client and the cloud service provider that win the auction and a transaction price thereof according to the first bid price from the client and the second bid price from the cloud service provider comprises:
establishing a winner determination model according to the first bid price and the second bid price in order to maximize an overall revenue of the client and the cloud service provider; and
solving the winner determination model to obtain the client and the cloud service provider that win the auction and the transaction price thereof.

3. The method according to claim 2, wherein the winner determination model is denoted as formula (1):
$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ {\hat{B}}_{i} ( 1 )} {x}_{i} = {\sum }_{j ∈ \hat{J} , r = \hat{{A}_{j}} ( 1 )} {y}_{j} ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 1 )$$
where Î is a set of clients; Ĵ is a set of cloud service provider; xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; \hat{R} is a merchandise set; B_{î}(1) is a set of first bid price accepted by the i^{th} client; A_{ĵ}(1) is a set of second bid price accepted by the j^{th} cloud service provider.

4. The method according to claim 3, wherein solving the winner determination model to obtain the client and the cloud service provider that win the auction and the transaction price thereof comprises:
obtaining the utility function of the i^{th} client according to formula (2),
$${U}_{i} ( {S}_{i} ) = {v}_{i}^{S} - {\sum }_{r ∈ S} {P}_{i}^{r} \qquad ( 2 )$$
where S is a set of merchandises to be wanted, vᵢ^{S} is a total cost of merchandises in S in the first bid price of the i^{th} client,
$${\sum }_{r ∈ S} {P}_{i}^{r}$$
is an actual transaction price of merchandises in S;
obtaining the revenue function of the j^{th} cloud service provider according to formula (3),
Wⱼ(rⱼ)=Pⱼ^{r}−cⱼ^{r} (3)
where Pⱼ^{r} is an actual transaction price of the r^{th} merchandise of the j^{th} cloud service provider, cⱼ^{r} is a second bid price of the r^{th} merchandise of the j^{th} cloud service provider;
simplifying formula (1) into formula (4) according to formula (2) and formula (3):
$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 4 )$$
where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element aᵣⱼ in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0);
introducing a Lagrangian relaxation factor λ into formula (4) to obtain formula (5),
z_{LR}(λ)=max L(x,y;λ)
s.t. 0≦yⱼ≦qⱼ∀jεĴ
0≦xᵢ≦1∀iεÎ (5)
where
$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) , L D$$
presents a dual problem of the winner determination problem IP;
obtaining the dual problem LD of the winner determination problem IP according to formula (6),
z_{LD}=min z_{LR}(λ)
s.t. λᵣ≧0∀rε\hat{R} (6)
solving the dual problem LD by a sub-gradient algorithm to obtain the client and the cloud service provider that win the auction and the transaction price thereof in a predetermined iteration scope, where a sub-gradient is denoted as formula (7),
g=∂L(x,y;λ)/∂λ (7)
wherein in each iteration, the Lagrangian relaxation factor λ is changed along a direction of the sub-gradient according to formula (8),
λ^{(k+1)}=λ^{(k)}+t^{(k)}g^{(k)} (8),
where t^{(k)} is an iterative step, g^{(k)} is a sub-gradient of each iteration.

5. The method according to claim 3, wherein the first bid price is provided by the client through:
inputting (<S,v^{S}>) via a predetermined auction language to indicate that the client intents to purchase one unit of each kind of merchandises in a merchandise to be wanted set S with a total cost v^{S}, if the merchandises intended to be wanted are a group of merchandises with independent or complementary efficiencies and a required quantity of the each kind of merchandises is one unit;
inputting (<S,v^{S}>)^{≦n} via the predetermined auction language to indicate that the client intents to purchase one to n units of the each kind of merchandises in the set S respectively in which a total cost of one unit of the each kind of merchandises in the set S is v^{S}, if the merchandises intended to be wanted are the group of merchandises with independent or complementary efficiencies and the required quantity of the each kind of merchandises is at least one unit, wherein n is an integer larger than one;
inputting (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, if the merchandises intended to be wanted are a group of merchandises with substitutable efficiencies and a required quantity of the each kind of merchandises is one unit, wherein S₁∩S₂=Ø; and
inputting (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, if the merchandises intended to be wanted are the group of merchandises with substitutable efficiencies and the required quantity of the each kind of merchandises is at least one unit, wherein n is an integer larger than one.

6. The method according to claim 1, further comprising:
receiving an application for taking part in the auction from the client and the cloud service provider respectively; and
taking an authentication and an examination to complete an online registration for the client and the cloud service provider respectively such that the client and the cloud service provider distribute auction information online.

7. The method according to claim 1, further comprising:
setting a price lower limit of the client in the auction, wherein the first bid price of each merchandise from the client is larger than the price lower limit, and the price lower limit of the client is adjustable according to a previous deal record.

8. The method according to claim 7, further comprising:
setting a price upper limit of the cloud service provider in the auction, wherein the second bid price of each merchandise from the cloud service provider is less than the price upper limit, and the price upper limit of the cloud service provider is adjustable according to the previous deal record.

9. An auction system for an allocation of a mobile cloud resource, comprising:
a client configured to provide a first bid price about a quantity unit and a price of one or more merchandises to be wanted;
a cloud service provider configured to provide a second bid price about a quantity unit and a price of one or more merchandises to be sold; and
an online auction platform configured to obtain the client and the cloud service provider that win the auction and a transaction price thereof according to the first bid price from the client and the second bid price from the cloud service provider and to match identification information of the client and the cloud service provider that win the auction with each other such that the client and the cloud service provider can complete an online payment according to the matched identification information.

10. The system according to claim 9, wherein the online auction platform is configured to:
establish a winner determination model according to the first bid price and the second bid price in order to maximize an overall revenue of the client and the cloud service provider; and
solve the winner determination model to obtain the client and the cloud service provider that win the auction and the transaction price thereof.

11. The system according to claim 10, wherein the winner determination model is denoted as:
$$max ( {\sum }_{i ∈ \hat{I}} {x}_{i} {U}_{i} ( {S}_{i} ) + {\sum }_{j ∈ \hat{J}} {y}_{j} {W}_{j} ( {r}_{j} ) ) \\ s . t . {\sum }_{i ∈ \hat{I} , r ∈ {B}_{i} ( 1 )} {x}_{i} = {\sum }_{j ∈ \hat{J} , r = \hat{{A}_{j}} ( 1 )} {y}_{j} ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 1 )$$
where Î is a set of clients; Ĵ is a set of cloud service providers; xᵢ indicates that whether a first bid price of a i^{th} client is accepted (if xᵢ is equal to 1, it represents acceptation and if xᵢ is equal to 0, it represents failure); yⱼ indicates a number of merchandises sold by a j^{th} cloud service provider (if yⱼ is equal to 0, it represents that none merchandise is sold and a maximum value thereof is a quantity qⱼ of the merchandises that the j^{th} cloud service provider can provide); Uᵢ(Sᵢ) is a utility function of the i^{th} client; Wⱼ(rⱼ) is a revenue function of the j^{th} cloud service provider; \hat{R} is a merchandise set; B_{î}(1) is a set of first bid price accepted by the i^{th} client; A_{ĵ}(1) is a set of second bid price accepted by the j^{th} cloud service provider.

12. The system according to claim 11, wherein the online auction platform is further configured to:
obtain the utility function of the i^{th} client according to formula (2),
$${U}_{i} ( {S}_{i} ) = {v}_{i}^{S} - {\sum }_{r ∈ S} {P}_{i}^{r} \qquad ( 2 )$$
where S is a set of merchandises to be wanted, vᵢ^{S} is a total cost of merchandises in S in the first bid price of the i^{th} client,
$${\sum }_{r ∈ S} {P}_{i}^{r}$$
is an actual transaction price of merchandises in S;
obtain the revenue function of the j^{th} cloud service provider according to formula (3),
Wⱼ(rⱼ)=Pⱼ^{r}−cⱼ^{r} (3)
where Pⱼ^{r} is an actual transaction price of a r^{th} merchandise of the j^{th} cloud service provider, cⱼ^{r} is a second bid price of the r^{th} merchandise of the j^{th} cloud service provider;
simplify formula (1) into formula (4) according to formula (2) and formula (3):
$${z}_{IP} = max ( {\sum }_{i ∈ \hat{I}} {v}_{i} {x}_{i} - {\sum }_{j ∈ \hat{J}} {c}_{j} {y}_{j} ) \\ s . t . {\sum }_{i ∈ \hat{I}} {b}_{ri} {x}_{i} - {\sum }_{j ∈ \hat{J}} {a}_{rj} {y}_{j} = 0 ∀ r ∈ \hat{R} \\ {y}_{j} ∈ \{ 0 , 1 , … , {q}_{j} \} ∀ j ∈ \hat{J} \\ {x}_{i} ∈ \{ 0 , 1 \} ∀ i ∈ \hat{I} \qquad ( 4 )$$
where IP presents a winner determination problem, b is a 0-1 matrix of |\hat{R}|×|Î|, and each element bᵣᵢ in the matrix b indicates that whether the r^{th} merchandise is in a merchandise set of a first bid price of the i^{th} client (if bᵣᵢ is equal to 1, it presents yes, and if bᵣᵢ is equal to 0, it presents 0); a is a 0-1 matrix of |\hat{R}|×|Ĵ|, and each element aᵣⱼ in the matrix a indicates that whether the r^{th} merchandise is in a merchandise set of a second bid price of the j^{th} cloud service provider (if aᵣⱼ is equal to 1, it presents yes, and if aᵣⱼ is equal to 0, it presents 0);
introduce a Lagrangian relaxation factor λ into formula (4) to obtain formula (5),
z_{LR}(λ)=max L(x,y;λ)
s.t. 0≦yⱼ≦qⱼ∀jεĴ
0≦xᵢ≦1∀iεÎ (5)
where
$$L ( x , y ; λ ) = {\sum }_{i ∈ \hat{I}} {v}_{i} {x}_{i} - {\sum }_{j ∈ \hat{J}} {c}_{j} {y}_{j} + {\sum }_{r ∈ \hat{R}} {λ}_{r} ( {\sum }_{j ∈ \hat{J}} {a}_{rj} {y}_{j} - {\sum }_{i ∈ \hat{I}} {b}_{ri} {x}_{i} ) , L D$$
presents a dual problem of the winner determination problem IP;
obtain the dual problem LD of the winner determination problem IP according to formula (6),
z_{LD}=min z_{LR}(λ)
s.t. λᵣ≧0∀rε\hat{R} (6)
solve the dual problem LD by a sub-gradient algorithm to obtain the client and the cloud service provider that win the auction and the transaction price thereof in a predetermined iteration scope, where a sub-gradient is denoted as formula (7),
g=∂L(x,y;λ)/∂λ (7)
wherein in each iteration, the Lagrangian relaxation factor λ is changed along a direction of the sub-gradient according to formula (8),
λ^{(k+1)}=λ^{(k)}+t^{(k)}g^{(k)} (8),
where t^{(k)} is an iterative step, g^{(k)} is a sub-gradient of each iteration.

13. The system according to claim 9, wherein the client is configured to:
input (<S,v^{S}>) via a predetermined auction language to indicate that the client intents to purchase one unit of each kind of merchandises in a merchandise to be wanted set S with a total cost v^{S}, if the merchandises intended to be wanted are a group of merchandises with independent or complementary efficiencies and a required quantity of the each kind of merchandises is one unit;
input (<S,v^{S}>)^{≦n} via the predetermined auction language to indicate that the client intents to purchase one to n units of the each kind of merchandises in the set S respectively in which a total cost of one unit of the each kind of merchandises in the set S is v^{S}, if the merchandises intended to be wanted are the group of merchandises with independent or complementary efficiencies and the required quantity of the each kind of merchandises is at least one unit, wherein n is an integer larger than one;
input (<S₁,v^{S}^{₁}>→<S₂,v^{S}^{₂}>) via the predetermined auction language to indicate that the client intents to purchase one unit of each kind of merchandises in a set S₁ with a total cost v^{S}^{₁} or to purchase one unit of the each kind of merchandises in the set S₁ and one unit of each kind of merchandises in a set S₂ simultaneously with a total cost v^{S}^{₂}, if the merchandises intended to be wanted are a group of merchandises with substitutable efficiencies and a required quantity of the each kind of merchandises is one unit, wherein S₁∩S₂=Ø; and
input (<S₁,v^{S}^{₁}>→<S₂,v^{S}^{₂}>)^{≦n} via the predetermined auction language to indicate that the client intents to purchase one to n units of the each kind of merchandises in the set S₁ in which a total price of one unit of the each kind of merchandises in the set S₁ is v^{S}^{₁} or to purchase one to n units of the each kind of merchandises in the set S₁ and one to n units of the each kind of merchandises in the set S₂ simultaneously in which a total cost of one unit of the each kind of merchandises in the set S₁ and one unit of the each kind of merchandises in the set S₂ is v^{S}^{₂}, if the merchandises intended to be wanted are the group of merchandises with substitutable efficiencies and the required quantity of the each kind of merchandises is at least one unit, wherein n is an integer larger than one.

14. The system according to claim 9, wherein the online auction platform is configured to:
receive an application for taking part in the auction from the client and the cloud service provider respectively; and
take an authentication and an examination to complete an online registration for the client and the cloud service provider respectively such that the client and the cloud service provider distribute auction information online.

15. The system according to claim 9, wherein the online auction platform is further configured to set a price lower limit of the client in the auction, wherein the first bid price of the each merchandise from the client is larger than the price lower limit, and the price lower limit of the client is adjustable according to a previous deal record.

16. The system according to claim 15, wherein the online auction platform is further configured to set a price upper limit of the cloud service provider in the auction, wherein the second bid price of each merchandise from the cloud service provider is less than the price upper limit, and the price upper limit of the cloud service provider is adjustable according to the previous deal record.

17. A non-transit computer-readable storage medium, comprising a computer program, wherein when the computer program is running on a computer, the computer program is configured for executing following steps:
obtaining a first bid price from a client, wherein the first bid price is provided by the client about a quantity unit and a price of one or more merchandises to be wanted;
obtaining a second bid price from a cloud service provider, wherein the second bid price is provided by the cloud service provider about a quantity unit and a price of one or more merchandises to be sold;
obtaining the client and the cloud service provider that win the auction and a transaction price thereof according to the first bid price from the client and the second bid price from the cloud service provider; and
matching identification information of the client and the cloud service provider that win the auction with each other such that the client and the cloud service provider can complete an online payment according to the matched identification information.
